(19) United States
(12) Patent Application Publication
(10) Pub. No.: US 2007/0002476 A1
(43) Pub. Date: Jan. 4, 2007

(54) Reflection mirror assembly

(76) Inventor: Chun-Hsien Chiang, Sinihuang City (TW)

Correspondence Address: BIRCH STEWART KOLASCH & BIRCH, PO BOX 747, FALLS CHURCH, VA, 22040-0747, US

(21) Appl. No.: 11/171,362

(22) Filed: Jul. 1, 2005

(51) Int. Cl. G02B 7/182

(52) U.S. Cl. 359/871; 359/831

(57) ABSTRACT

A reflection mirror assembly includes a seat having two opposite walls, two open sides, and an open top; and a hood having two integrally formed and oppositely located bevel faces that have an internally threaded hole each for at least two tubes to screw thereto. The hood is closed onto the seat to close the open top and the two open sides of the seat, so that a closed space is defined between the seat and the hood. The closed-space is communicable with the through holes on the bevel faces of the hood. A reflection mirror is positioned in the closed space to reflect rays passing through the two tubes.

### FIELD OF THE INVENTION

The present invention relates to a reflection mirror assembly, and more particularly to a reflection mirror assembly that can be quickly assembled.

### BACKGROUND OF THE INVENTION

U.S. Pat. No. 6,814,455 discloses a reflection mirror assembly including a case formed from an aluminum extruded tube, two covers, and a reflection mirror. The case includes a seat, a first bevel face provided with a through hole for a first tube to mount therein, a second bevel face provided with a through hole for a second tube to mount therein, and two open sides. The two covers are separately assembled to the two open sides of the seat to close the same. The reflection mirror is positioned in the case on the seat.

The first and second bevel faces and the two covers are provided with more than two threaded holes for screws to extend therethrough, so as to connect the two covers to the first and second bevel faces.

In assembling the above-structured reflection mirror assembly, it is necessary to separately assemble the two covers to the two open sides of the case, and extend more than four screws through the two covers to close them onto the two open sides of the case. It is time and labor consuming to do so, and the working efficiency, accuracy, and correctness thereof is low. The multiple screws require a lot of time to tighten and result in complicate assembling process and increased material cost.

It is therefore tried by the inventor to develop an improved reflection mirror assembly to overcome the above-mentioned problems.

### SUMMARY OF THE INVENTION

A primary object of the present invention is to provide a reflection mirror assembly that includes a seat having two integrally formed and oppositely located walls, and a hood having two opposite bevel faces for closing onto the seat to define a closed space between the seat and the hood to hold a reflection mirror therein.

Another object of the present invention is to provide a reflection mirror assembly that has simple structure to enable quick assembling and reduced manufacturing cost thereof.

To achieve the above and other objects, the reflection mirror assembly according to the present invention includes a seat having two opposite walls, two open sides, and an open top; and a hood having two integrally formed and oppositely located bevel faces that have an internally threaded hole each for at least two tubes to screw thereto. The hood is closed onto the seat to close the open top and the two open sides of the seat, so that a closed space is defined between the seat and the hood. The closed space is communicable with the through holes on the bevel faces of the hood, allowing a reflection mirror positioned in the closed space to reflect rays passing through the two tubes.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a reflection mirror assembly according to a preferred embodiment of the present invention;

FIG. 2 is an assembled view of FIG. 1;

FIG. 3 is a sectioned front view of the reflection mirror assembly of FIG. 1; and

FIG. 4 is a sectioned front view of another embodiment of the present invention.

### DETAILED DESCRIPTION OF THE PREFERRED EMBODIMENTS

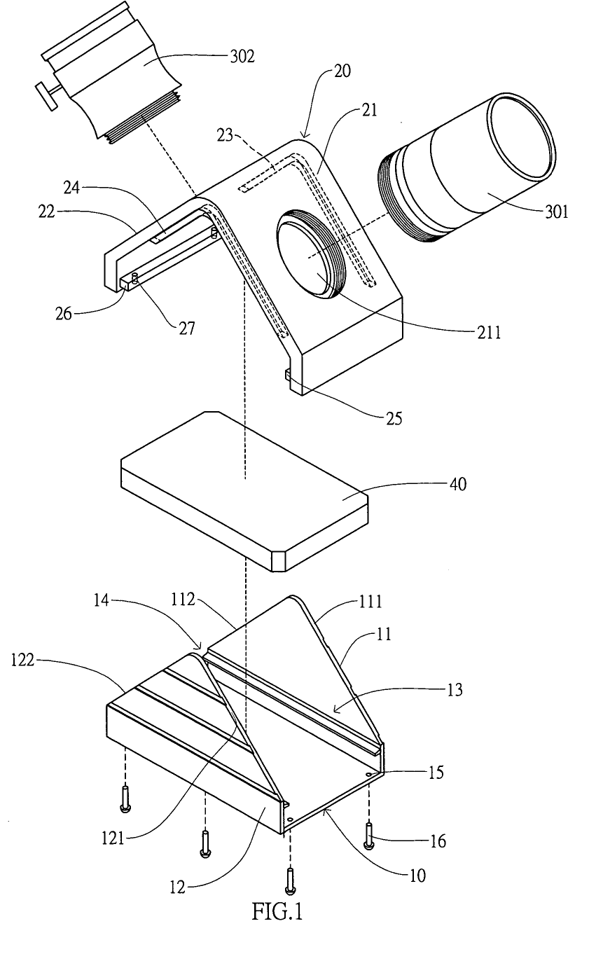

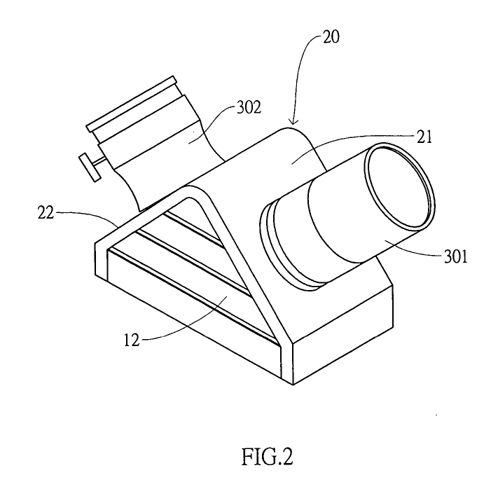

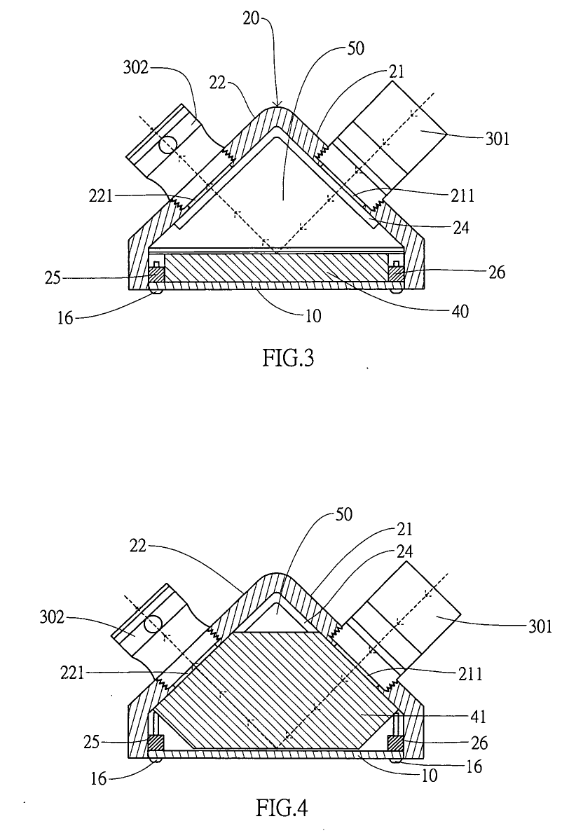

Please refer to FIGS. 1 to 3 in which a reflection mirror assembly according to a preferred embodiment of the present invention is shown. As shown, the reflection mirror assembly includes a seat 10, a hood 20, at least two tubes 301, 302, and a reflection mirror 40.

The seat 10 is provided at predetermined positions on a bottom thereof with a plurality of through holes 15, via each of which a fastening element 16 may be extended. The seat 10 includes two oppositely spaced first and second walls 11, 12, and two oppositely located first and second open sides 13, 14. The first and second walls 11, 12 are integrally formed on the seat 10 to vertically and upward extend from the bottom of the seat 10 to together define a first pair of bevel edges 111, 121 and a second pair of bevel edges 112, 122. The seat 10 has an open top continuously extended to the first and second open sides 13, 14.

The hood 20 includes two integrally formed first and second bevel faces 21, 22, on which a first and a second internally threaded through hole 211, 221 are provided, respectively, as can be clearly seen from FIG. 3. A first and a second locating rib 23, 24 are spaced on one side of the first and the second bevel face 21, 22 facing toward the first and the second pair of bevel edges 111, 121 and 112, 122. A first and a second fixing ribs 25, 26 are provided across a lower inner edge of the first and the second bevel face 21, 22, respectively, and have through holes 27 provided thereon corresponding to the through holes 15 on the bottom of the seat 10, so that the fastening elements 16 may be upward extended through the through holes 15 into the through holes 27.

The at least two tubes 301, 302 are first and second tubes 301, 302 being externally threaded at respective one end. The first tube 301 is screwed into the internally threaded first through hole 211 on the first bevel face 21, and the second tube 302 into the internally threaded second through hole 221 on the second bevel face 22.

The reflection mirror 40 is adapted to reflect rays therefrom.

In the illustrated preferred embodiment of the present invention, there are four through holes 15 provided on the seat 10, and the through holes 27 on the fixing ribs 25, 26 of the hood 20 and the fastening elements 16 are in the number corresponding to that of the through holes 15.

To assemble the reflection mirror assembly of the present invention, first position the reflection mirror 40 on the seat 10 between the first and the second wall 11, 12 and the first and the second open side 13, 14. Then, close the hood 20 onto the open top of the seat 10 with the first and the second bevel face 21, 22 of the hood 20 seated on the first pair of bevel edges 111, 121 and the second pair of bevel edges 112, 122, respectively, so that the hood 20 closes the open top and the first and the second open side 13, 14 of the seat 10. At this point, the first and the second locating ribs 23, 24 are abutted against an inner side of the first and the second wall 11, 12, respectively; and the first and the second fixing rib 25, 26 are seated on the two open sides 13, 14 of the seat 10, and the fastening elements 16 may be upward threaded through the through holes 15 on the seat 10 into the through holes 27 on the first and the second fixing rib 25, 26, to firmly connect the hood 20 to the top of the seat 10 to define a closed space 50 in the seat 10, as shown in FIG. 3, with the reflection mirror 40 positioned therein. The closed space 50 is communicable with the first and the second through hole 211, 221 on the first and the second bevel face 21, 22, respectively. Finally, screw the externally threaded end of the first and the second tube 301, 302 to the internally threaded through holes 211, 221, respectively, to connect the first and the second tube 301, 302 to the first and the second bevel face 21, 22. In this manner, rays passing through the first and the second tube 301, 302 may be reflected by the reflection mirror 40.

In the reflection mirror assembly of the present invention, the open top and the first and the second open side 13, 14 of the seat 10 could be simultaneously closed to define the closed space 50 in the seat 10 simply by closing the hood 20 onto the top of the seat 10. The reflection mirror assembly of the present invention can therefore be completed in simplified procedures and reduced time, labor, and material costs to achieve high good yield.

Moreover, since the seat 10 has an open top and two open sides 13, 14 before the hood 20 is closed onto the seat 10, the reflection mirror 40 could be conveniently and quickly positioned in the seat 10.

In another embodiment of the present invention, a prism 41 is used to replace the reflection mirror 40 to refract rays passing through the first and the second tube 301.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A reflection mirror assembly, comprising:
a seat being provided at predetermined positions with a plurality of through holes, via each of which a fastening element may be extended; said seat including two oppositely spaced first and second walls, and two oppositely located first and second open sides; said first and second walls being integrally formed on said seat to vertically and upward extend from a bottom of said seat to together define a first pair of bevel edges and a second pair of bevel edges; and said seat including an open top continuously extended to said first and second open sides of said seat;
a hood including two integrally formed first and second bevel faces, on which a first and a second through hole are provided; said hood being closed onto the open top of said seat with said first and said second bevel face seated on said first and said second pair of bevel edges on said first and said second wall of said seat, so that said open top and said first and second open sides of said seat is closed by said hood; and said hood being firmly connected to said seat by upward extending said fastening elements through said seat into said hood;
a closed space defined by said first and second walls of said seat and said first and second bevel faces of said hood closed onto said seat; said closed space being communicable with said first and second through holes on said first and second bevel faces, respectively;
at least two tubes, namely, a first and a second tube, being respectively mounted in said first through hole on said first bevel face, and said second through hole on said second bevel face; and
a reflection mirror being positioned in said closed space in said seat and adapted to reflect rays passing through said first and said second tube.

2. The reflection mirror assembly as claimed in claim 1, wherein said reflection mirror is replaced with a prism.

3. The reflection mirror assembly as claimed in claim 1, wherein said first and second through holes on said first and second bevel faces of said hood, respectively, are internally threaded.

4. The reflection mirror assembly as claimed in claim 3, wherein said first and second tubes are provided at respective one end with external threads to mesh with said internally threaded first and second through holes on said hood.

5. The reflection mirror assembly as claimed in claim 1, wherein said first and second bevel faces of said hood are provided on one side facing toward said first and second pairs of bevel edges with spaced first and second locating ribs; and said first and second locating ribs being abutted against an inner side of said first and second walls when said hood is closed onto said seat.

6. The reflection mirror assembly as claimed in claim 1, wherein said first and second bevel faces of said hood are provided across respective lower inner edge with a first and a second fixing ribs, on which through holes are provided corresponding to said through holes on said seat, so that said fastening elements may be upward extended through said through holes on said seat into said through holes on said fixing ribs to connect said seat to said hood.

7. The reflection mirror assembly as claimed in claim 5, wherein said first and second bevel faces of said hood are provided across respective lower inner edge with a first and a second fixing ribs, on which through holes are provided corresponding to said through holes on said seat, so that said fastening elements may be upward extended through said through holes on said seat into said through holes on said fixing ribs to connect said seat to said hood.

8. The reflection mirror assembly as claimed in claim 1, wherein said through holes on said seat are in the number of four, and said fastening elements are in the number of four corresponding to said through holes on said seat.

9. The reflection mirror assembly as claimed in claim 5, wherein said through holes on said seat are in the number of four, and said fastening elements are in the number of four corresponding to said through holes on said seat.
